(19) United States
(12) Patent Application Publication
(10) Pub. No.: US 2025/0052624 A1
(43) Pub. Date: Feb. 13, 2025

(54) FLEXIBLE FORCE MEASURING TACTILE SENSOR SYSTEM

(71) Applicant: HACETTEPE UNIVERSITESI REKTORLUK, Cankaya/Ankara (TR)

(72) Inventors: Dincer GOKCEN, Ankara (TR); Yeter SEKERTEKIN, Ankara (TR)

(73) Assignee: HACETTEPE UNIVERSITESI REKTORLUK, Cankaya/Ankara (TR)

(21) Appl. No.: 18/719,444

(22) PCT Filed: Dec. 19, 2022
(86) PCT No.: PCT/TR2022/051524

§ 371 Date: Jun. 13, 2024

(30) Foreign Application Priority Data
Dec. 19, 2021 (TR) 2021/020374

(51) Int. Cl. G01L 1/14; B82Y 15/00; B82Y 30/00; B82Y 40/00; G01B 7/00; G01B 7/16

(52) U.S. Cl. CPC G01L 1/144; G01B 7/003; G01B 7/18; B82Y 15/00; B82Y 30/00; B82Y 40/00

(57) ABSTRACT

The present invention relates to a system which is produced with a nano-composite-based dielectric material positioned between nanocomposite-based electrode pairs with serpentine geometry, so to be used as a tactile sensor that can measure the tactile position and force simultaneously; and enables to measure the tactile position according to the resistance change and the tactile force according to the reactance change between electrode pairs.

### TECHNICAL FIELD

The present invention relates to a system for measuring touch position and touch force according to impedance value of serpentine electrode pairs so to be used as a tactile sensor that can measure the touch position and force simultaneously.

### BACKGROUND OF THE INVENTION

In the state of the art, only the position of a user's tactile inputs is detected, and different measurement methods are used to detect the position of a user's tactile inputs and to determine the magnitude of the applied force in most applications in tactile sensors. In input components with tactile interface, it is not possible to co-process the position and force information of a tactile input—which is measured by means of a plurality of sensors—and to interpret them as inputs with different characteristics.

Considering the deficiencies of tactile sensors included in the state of the art, it is seen that there is a need for a system for measuring touch position and touch force according to the impedance value of serpentine electrode pairs so to be used as a tactile sensor that can measure the touch position and force simultaneously, in the state of the art.

The United States patent document U.S. Pat. No. 10,613,695, an application in the state of the art, discloses a system for measuring the touch position and force by means of an integrated sensor structure. In the system of the said invention, a force electrode and a plurality of position electrodes are coupled to a capacitance measurement unit, the self-capacitance values of the position electrodes are compared by leaving the force electrode afloat to detect the touch position, the common capacitance values of the force electrode are compared with the position electrodes by sending a transmission signal to the force electrode in order to measure the touch force.

### SUMMARY OF THE INVENTION

The objective of the present invention is to realize a system which is produced with a nanocomposite-based dielectric material positioned between nanocomposite-based electrode pairs with serpentine geometry, so to be used as a tactile sensor that can measure the tactile position and force simultaneously; and enables to measure the tactile position according to the resistance change and the tactile force according to the reactance change between electrode pairs.

### DETAILED DESCRIPTION OF THE INVENTION

“Flexible Force Meter Tactile Sensor System” realized to fulfill the objective of the present invention is shown in the FIGURE attached, in which:

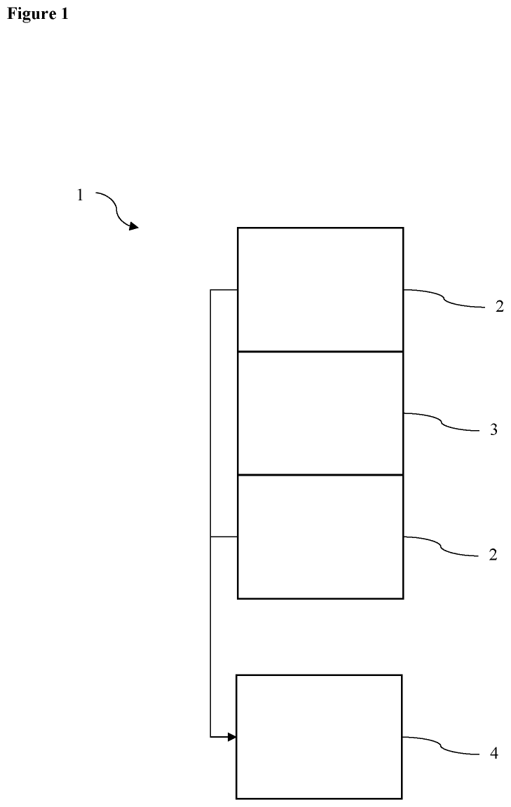

FIG. 1 is a schematic block diagram of the inventive system.

The components illustrated in the FIGURE are individually numbered, where the numbers refer to the following:
1. System
2. Serpentine electrode pair
3. Dielectric separator
4. Impedance measurement unit

The inventive system (1) which is produced with a nanocomposite-based dielectric material positioned between nanocomposite-based electrode pairs with serpentine geometry, so to be used as a tactile sensor that can measure the tactile position and force simultaneously; and enables to measure the tactile position according to the resistance change and the tactile force according to the reactance change between electrode pairs comprises:
at least one serpentine electrode pair (2) which is configured to be produced on a nanocomposite-based flexible substrate with serpentine geometry, and to be placed with an overlapping pattern geometry;
a dielectric separator (3) which is configured to be positioned between the electrodes within the serpentine electrode pair (2), to be produced with a dielectric characteristic and flexible structure as nanocomposite-based, and to ensure the electrical isolation of electrodes; and
at least one impedance measurement unit (4) which is configured to be electrically coupled to the starting and ending terminal of both electrodes within the serpentine electrode pair (2), to measure the impedance value of the serpentine electrode pair, and to report the touch position and force according to the impedance measurement.

The serpentine electrode pair (2) included in the inventive system (1) is configured to be produced on a nanocomposite-based flexible substrate with serpentine geometry, and to be placed with an overlapping pattern geometry. In a preferred embodiment of the invention, the serpentine electrode pair (2) is configured to enable the impedance change during touching to be recorded by the measurement unit upon being coupled to a measurement unit. In a preferred embodiment of the invention, the serpentine electrode pair (2) is configured to be prepared in the form of an ink consisting of carbon black and sodium alginate and to be produced by means of screen printing techniques on a flexible substrate.

The dielectric separator (3) included in the inventive system (1) is configured to be positioned between the electrodes within the serpentine electrode pair (2), to be produced with a dielectric characteristic and flexible structure as nanocomposite-based, and to ensure the electrical isolation of electrodes. In a preferred embodiment of the invention, the dielectric separator (3) is configured to be produced as flexible and polypropylene-based.

The impedance measurement unit (4) included in the inventive system (1) is configured to be electrically coupled to the starting and ending terminal of both electrodes within the serpentine electrode pair (2), to measure the impedance value of the serpentine electrode pair, and to report the touch position and force according to the impedance measurement. In a preferred embodiment of the invention, the impedance measurement unit (4) is configured to report the touch positions mapped to the resistance values obtained from the impedance value of the serpentine electrode pair (2). In a preferred embodiment of the invention, the impedance measurement unit (4) is configured to report the touch forces mapped to the reactance values obtained from the impedance value of the serpentine electrode pair (2).

### INDUSTRIAL APPLICABILITY OF THE INVENTION

In the inventive system (1), at least one serpentine electrode pair (2) is formed by printing a nanocomposite ink consisting of carbon black and sodium alginate on both sides of the flexible and polypropylene-based dielectric separator (3) with an overlapping geometry by means of screen printing techniques and a total of 4 terminals of each serpentine electrode pair (2), namely 2 for each electrode, are coupled to at least one impedance measurement unit (4). When a tactile input is created, the impedance change at the electrodes is received by the impedance measurement unit (4) due to the position of the serpentine electrode pair (2) on both sides of the dielectric separator (3); the resistance and reactance values are extracted and then the touch positions and forces mapped to these values are reported; thus it is ensured that outputs of a human input interface are increased by one dimension by measuring the position and force of a tactile input simultaneously.

With the inventive system (1), it is ensured that outputs of a human input interface are increased by one dimension by measuring the position and force of a tactile input simultaneously.

Within these basic concepts; it is possible to develop a wide variety of applications of the inventive “Flexible Force Meter Tactile Sensor System (1)”; the invention cannot be limited to examples disclosed herein and it is essentially according to claims.

1. A system (1) which is produced with a nanocomposite-based dielectric material positioned between nanocomposite-based electrode pairs with serpentine geometry, so to be used as a tactile sensor that can measure the tactile position and force simultaneously; and enables to measure the tactile position according to the resistance change and the tactile force according to the reactance change between electrode pairs characterized by:
at least one serpentine electrode pair (2) which is configured to be produced on a nanocomposite-based flexible substrate with serpentine geometry, and to be placed with an overlapping pattern geometry;
a dielectric separator (3) which is configured to be positioned between the electrodes within the serpentine electrode pair (2), to be produced with a dielectric characteristic and flexible structure as nanocomposite-based, and to ensure the electrical isolation of electrodes; and
at least one impedance measurement unit (4) which is configured to be electrically coupled to the starting and ending terminal of both electrodes within the serpentine electrode pair (2), to measure the impedance value of the serpentine electrode pair, and to report the touch position and force according to the impedance measurement.

2. A system (1) according to claim 1; characterized by the serpentine electrode pair (2) which is configured to enable the impedance change during touching to be recorded by the measurement unit, upon being coupled to a measurement unit.

3. A system (1) according to claim 1; characterized by the serpentine electrode pair (2) which is configured to be prepared in the form of an ink consisting of carbon black and sodium alginate and to be produced by means of screen printing techniques on a flexible substrate.

4. A system (1) according to claim 1; characterized by the dielectric separator (3) which is configured to be produced as flexible and polypropylene-based.

5. A system (1) according to claim 1; characterized by the impedance measurement unit (4) which is configured to report the touch positions mapped to the resistance values obtained from the impedance value of the serpentine electrode pair (2).

6. A system (1) according to claim 1; characterized by the impedance measurement unit (4) which is configured to report the touch forces mapped to the reactance values obtained from the impedance value of the serpentine electrode pair (2).
